(19) United States
(12) Patent Application Publication
(10) Pub. No.: US 2014/0032103 A1
(43) Pub. Date: Jan. 30, 2014

(54) METHOD OF DISPLAYING A FLIGHT PLAN

(71) Applicants: Dashiell Matthews Kolbe, Grand Rapids, MI (US); Brian Jacob Loyal, Grandville, MI (US); Philip Dewing Sugimoto, Rockford, MI (US); Peter Jacob Conrardy, Tampa, FL (US)

(72) Inventors: Dashiell Matthews Kolbe, Grand Rapids, MI (US); Brian Jacob Loyal, Grandville, MI (US); Philip Dewing Sugimoto, Rockford, MI (US); Peter Jacob Conrardy, Tampa, FL (US)

(73) Assignee: GE AVIATION SYSTEMS LLC, Grand Rapids, MI (US)

(21) Appl. No.: 13/558,599

(22) Filed: Jul. 26, 2012

(51) Int. Cl. G01C 23/00

(52) U.S. Cl. 701/466; 701/528

(57) ABSTRACT

A method of displaying a flight plan on a flight display of a flight deck of an aircraft, where the method includes displaying at least a portion of the flight plan on the display and determining an unsuitability of at least a portion of the flight plan based on at least one suitability criteria.

### BACKGROUND OF THE INVENTION

Contemporary aircraft may include a flight management system (FMS). The FMS automates a wide variety of in-flight tasks and one of its primary functions is in-flight management of the flight plan. The flight plan may be modeled as a trajectory that can be comprised of a plurality of waypoints. The FMS may be capable of receiving input from a pilot regarding the flight plan but the pilot receives no information related to the suitability of the flight plan.

### BRIEF DESCRIPTION OF THE INVENTION

In one embodiment, the invention relates to a method of displaying a flight plan on a display of a flight deck of an aircraft, including displaying at least a portion of the flight plan on the display, determining an unsuitability of the at least a portion of the flight plan based on at least one suitability criteria, and displaying on the display indicia related to the determined unsuitability.

### BRIEF DESCRIPTION OF THE DRAWINGS

In the drawings:

FIG. 1 is a perspective view of a portion of an aircraft cockpit with a flight display on which at least a portion of a flight plan may be displayed according to embodiments of the invention.

FIG. 2 is a schematic view of a display of a flight plan and display indicia related to a determined unsuitability according to a first embodiment of the invention.

### DESCRIPTION OF EMBODIMENTS OF THE INVENTION

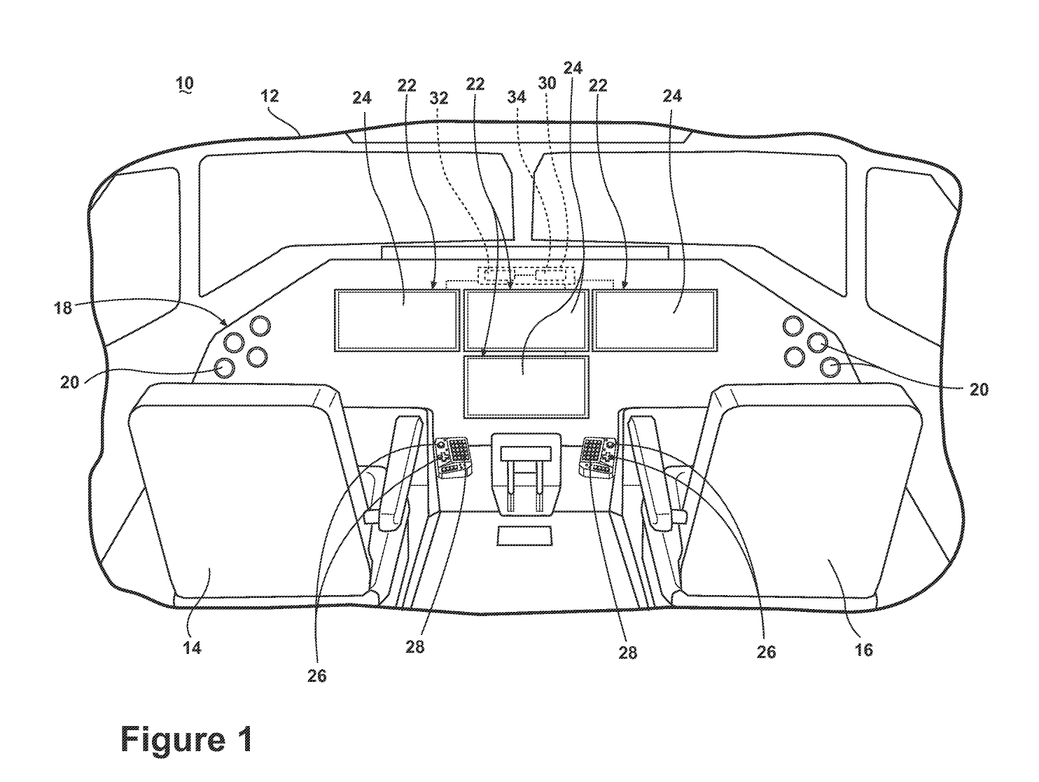

FIG. 1 illustrates a portion of an aircraft 10 having a cockpit 12. While a commercial aircraft has been illustrated, it is contemplated that embodiments of the invention may be used in any type of aircraft allowing for a flight plan to be selected and displayed. A first user (e.g., a pilot) may be present in a seat 14 at the left side of the cockpit 12 and another user (e.g., a co-pilot) may be present at the right side of the cockpit 12 in a seat 16. A cockpit instrument panel or flight deck 18 having various instruments 20 and multiple multifunction flight displays 22 may be located in front of the pilot and co-pilot and may provide the flight crew with information to aid in flying the aircraft 10.

The flight displays 22 may include either primary flight displays or multi-function displays and may display a wide range of aircraft, flight, navigation, and other information used in the operation and control of the aircraft 10. The flight displays 22 may be capable of displaying color graphics and text to a user. The flight displays 22 may be laid out in any manner including having fewer or more displays and need not be coplanar or the same size. A touch screen display or touch screen surface 24 may be included in the flight display 22 and may be used by one or more flight crew members, including the pilot and co-pilot, to interact with the systems of the aircraft 10. It is contemplated that one or more cursor control devices 26, such as a mouse, and one or more multifunction keyboards 28 may be included in the cockpit 12 and may also be used by one or more flight crew members to interact with the systems of the aircraft 10.

A controller 30 may be operably coupled to components of the aircraft 10 including the flight displays 22, touch screen surface 24, cursor control devices 26, and keyboards 28. The controller 30 may also be connected with other controllers (not shown) of the aircraft 10. The controller 30 may include memory, the memory may include random access memory (RAM), read-only memory (ROM), flash memory, or one or more different types of portable electronic memory, such as discs, DVDs, CD-ROMs, etc., or any suitable combination of these types of memory. The controller 30 may include processing units, which may be running any suitable programs to implement a graphical user interface (GUI) and operating system. These programs typically include a device driver that allows the user to perform functions on the touch screen surface 24 such as selecting options, inputting commands and other data, selecting and opening files, and moving icons through the touch screen surface 24. The controller 30 may be a portion of an FMS or may be operably coupled to the FMS.

The controller 30 may include a processor 32 and memory 34. A computer searchable database of information may be stored in the memory 34 and accessible by processor 32. The processor 32 may run a set of executable instructions to display the database or access the database. Alternatively, the controller 30 may be operably coupled to a database of information. For example, such a database may be stored on an alternative computer or controller. It will be understood that the database may be any suitable database, including a single database having multiple sets of data, multiple discrete databases linked together, or even a simple table of data.

The database may store imagery data that may include geo-specific terrain, man-made objects including runway and airport layouts, and additional imagery including aircraft traffic information. It is contemplated that the database may incorporate a number of databases or that the database may actually be a number of separate databases including a terrain data base, man-made obstacle database, geo-political database, hydrological database, and other databases. It is contemplated that the controller 30 retrieves and displays an image on the display by generating an image from the information and imagery data obtained from the multiple databases. The database may also include runway data, aircraft performance data, engine performance data, current weather conditions, and historical performance data. This data may be stored as performance attributes of the aircraft, geographic constraints, and weather constraints.

Alternatively, it is contemplated that the database may be separate from the controller but may be in communication with the controller 30 such that it may be accessed by either the controller 30. For example, it is contemplated that the database may be contained on a portable memory device and in such a case, the flight deck 18 may include a port for receiving the portable memory device and such a port would be in electronic communication with controller 30 such that controller 30 may be able to read the contents of the portable memory device. It is also contemplated that the database may be updated through a communication link and that in this manner real time information such as information regarding air traffic imagery may be included in the database and may be included in image displayed by the controller 30.

Further, it is contemplated that such a database may be located off the aircraft 10 at a location such as airline or flight operations department control (not shown) or another location and that the controller 30 may be operably coupled to a wireless network (not shown) over which the database information may be provided to the controller 30. For example, the weather data may be obtained from a weather database which may contain real-time weather data or forecasted weather data. Such weather databases may contain information regarding certain weather-related phenomena (e.g., wind speed, wind direction, temperature, among others) and data pertaining to visibility (e.g., foggy, cloudy, etc.), precipitation (rain, hail, snow, freezing rain, etc.) and other meteorological information. Because air temperature, wind direction, and wind speed must be accounted for in trajectory calculations to ensure that the aircraft can accurately conform to the desired trajectory, the weather database may include 3-D real-time temperature and wind models of the local airspace as well as 4-D forecasted data. The weather database may store such real-time or forecasted weather data based at a specific latitude, longitude, and altitude.

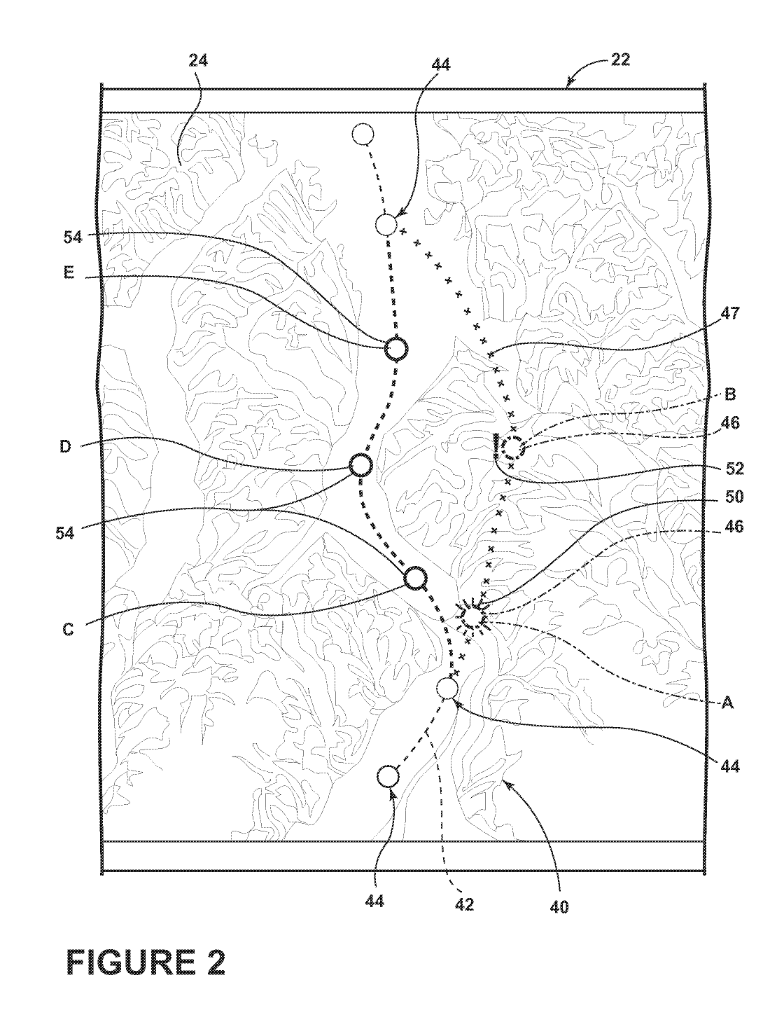

During operation, the aircraft 10 may display at least a portion of the flight plan on the flight display 22, compare at least a portion of the flight plan to at least one suitability criteria, determine an unsuitability of the at least a portion of the flight plan based on the comparison, and display on the display indicia related to the determined unsuitability. By way of non-limiting example, the controller 30 may utilize inputs from the pilot, the database, and/or information from airline control or flight operations department to present a graphical depiction of the surrounding of the aircraft 10 or a future surrounding of the aircraft 10. For example, as illustrated in FIG. 2, a map 40 may be displayed on the flight display 22. The map 40 may illustrate a visual representation of the terrain underlying the flight plan of the aircraft 10. It will be understood that the map 40 may be graphically illustrated in a variety of ways and that various objects, such as the runway, may be illustrated on the flight display 22 to better aid the pilot in making decisions. Further, the map 40 may take any variety of forms including a 2D map, a 3D map, a topographical map, etc.

At least a portion of a flight plan 42 including one or more waypoints 44 may be displayed on the map 40. The information forming the flight plan 42, including the information for the waypoints 44 may be provided to the controller 30 by the pilot, the database, and/or information from airline control or flight operations department. Regardless of the manner of input or where the information originated, when the information related to the flight plan 42 is received by the controller 30 the controller 30 may then display such a flight plan 42 on the flight display 22.

The controller 30 may determine an unsuitability of at least a portion of the flight plan 42 based on at least one suitability criteria. In implementation, the one or more suitability criteria may be converted to an algorithm, which may be converted to a computer program comprising a set of executable instructions, which may be executed by the controller 30, which has access to the flight plan 42 and waypoints 44 entered into the FMS. In this way, one or more particular waypoints 44 or portions of the flight plan 42 may be compared to the suitability criteria and a determination may be made if the one or more particular waypoints 44 or portions of the flight plan 42 satisfy the suitability criteria. If so, the one or more particular waypoints 44 or portions of the flight plan 42 may be considered suitable.

More specifically, the controller 30 may determine an unsuitability of at least a portion of the flight plan 42 based on one or more suitability criteria. For example, the unsuitability of at least a portion of the flight plan 42 may be determined by the controller 30 based on suitability criteria, which may include at least one of pilot suitability criteria, which is set by the pilot and airline suitability criteria, which may be set by the airline or airline operations control. The suitability criteria may include at least one of destination arrival time, weather preferences, and proximity preferences. By way of further example, the suitability criteria may include a speed preferences, bank angle preferences, etc. The destination arrival time may include a range of suitable times for the destination arrival. Weather preferences may include a preferred distance from inclement weather. Proximity preferences may include staying out of no-fly zones such as military operations areas or a preferred distance from high-altitude features. Taking into account any amount of the information above, the controller 30 may determine an unsuitability of at least a portion of the flight plan 42 by determining if the at least one suitability criteria would be satisfied if the aircraft 10 traveled the flight plan 42. If at least a portion of the flight plan 42 would cause the at least one suitability criteria to not be satisfied, then the controller 30 may determine that such a portion of the flight plan 42 is unsuitable.

In this manner, determining an unsuitability of at least a portion of the flight plan 42 based on at least one suitability criteria may include the controller 30 comparing at least a portion of the flight plan 42 to at least one suitability criteria. For example, this may include comparing a trajectory of the aircraft 10 along the flight plan 42 against the at least one suitability criteria. This may include generating a predicted trajectory based on at least one of weather, terrain, fixed obstacles, and variable obstacles, and flight characteristics or performance attributes of the aircraft 10. Embodiments of the invention may use a database of terrain, weather, and additional information to generate the predicted trajectory to be compared with the at least one suitability criteria. It is contemplated that determining the unsuitability of the at least a portion of the flight plan 42 may include determining the unsuitability while the aircraft 10 is being flown along the flight plan 42. Thus, current time and location of the aircraft 10 may also be considered in predicting the trajectory of the aircraft 10.

As yet another example, a pilot's or airline's constraints may also be considered by the controller 30 in generating the predicted trajectory. For example, a pilot's flight preferences may be one type of constraint. If the pilot prefers not to fly within a certain range of a mountain, then the controller 30 may utilize such information in generating the predicted trajectory. Further still, historical flight data on the specific flight plan 42 may be considered in generating the predicted trajectory.

By way of non-limiting example, once the trajectory of the aircraft 10 has been predicted it may be compared to at least one suitability criteria. As one example, the predicted trajectory may be compared with a destination arrival time. If the controller 30 determines that at least a portion of the flight plan 42 would cause the destination arrival time to not be satisfied, then the controller 30 may determine that such a portion of the flight plan 42 is unsuitable.

The term “satisfies” the at least one suitability criteria is used herein to mean that the predicted trajectory satisfies the predetermined at least one suitability criteria, such as being equal to, less than, or greater than the at least one suitability criteria. It will be understood that such a determination may easily be altered to be satisfied by a positive/negative comparison or a true/false comparison. For example, less than the at least one suitability criteria can easily be satisfied by applying a greater than test when the data is numerically inverted. It will be understood that in determining unsuitability or suitability of a portion of a flight plan 42 that unsuitability criteria may be used. In such an instance, if a portion of a flight plan 42 fails the unsuitability criteria, it is suitable.

Based on the determination of an unsuitability of at least a portion of the flight plan 42, the controller 30 may display on the flight display 22 indicia related to the determined unsuitability. The indicia displayed may be any suitable indicia to indicate that the portion of the flight plan 42 has been determined to be unsuitable. Further, the indicia may be displayed in any suitable display manner. Any portion of the flight plan 42 that does not satisfy the suitability criteria may be indicated to the user through indicia to inform the user of areas of the flight plan 42 that are not in agreement with the criteria.

In the illustrated example, the waypoints 46 and the portions of the flight plan 47 have been determined to be unsuitable. This includes the waypoints denoted A and B, which have determined to be unsuitable. By way of further example, the displaying the indicia has been illustrated as including flagging the waypoint A and the waypoint B. For example, the waypoint A has been flagged with indicia 50 and the waypoint B has been flagged with alternative indicia 52. It is contemplated that the displayed flagged waypoints A and/or the displayed flagged waypoint B or their corresponding indicia 50 and 52 may be user selectable. It is contemplated that upon the selection of the flagged waypoint or the displayed indicia that the controller 30 may display information regarding the unsuitability of the corresponding waypoint. For example, the information may include why the waypoint was determined to be unsuitable. The information may also include information related to altering the flight plan 42 to obtain a flight plan 42 that will satisfy the at least one suitability criteria.

As illustrated, the indicia may be associated with a corresponding portion of the flight plan 42. For example, the indicia may be displayed near the corresponding portion of the flight plan 42 or the indicia may be displayed on the corresponding portion of the flight plan 42. Further still, the indicia may be shown in a portion of the flight display 22 not associated with the corresponding portion of the flight plan 42, such as a text box in a corner of the flight display 22.

Further, as illustrated, at least a suitable portion of a flight plan or at least one suitable alternative waypoint location may be displayed when the at least a portion of the flight plan 42 is determined to be unsuitable. It is contemplated that this may be in addition to the indicia or that the indicia displayed may be the suitable alternative to the at least a portion of the flight plan 42, which was determined to be unsuitable. In the illustrated example, a suitable portion of a flight plan including a series of suitable alternative waypoints have been displayed and denoted as 54. The suitable alternative waypoints 54 may form an alternative flight plan that creates a suitable flight plan based on the at least one suitability criteria. By way of example, the alternative waypoints 54 may be determined by the controller 30 based on at least one of weather, terrain, fixed obstacles, variable obstacles, flight characteristics of the aircraft 10, etc. Further, the controller 30 may look at other portions of the flight plan and the pilot's or airlines' constraints in determining the suitable alternative waypoints 54. While a series of suitable alternative waypoints 54 have been illustrated it will be understood that a single suitable alternative waypoint may be determined and displayed. Further, a variety of suitable alternative waypoints may be displayed to give the user a variety of choices.

Both the unsuitable portion of the flight plan 47 and the suitable flight plan including the suitable alternative waypoints 54 may be displayed on the flight display 22. As illustrated, the suitable alternative waypoints 54 may be displayed in a visually distinguishable manner from the remainder of the flight plan 42. Displaying the suitable alternative waypoints 54 in a distinguishable manner may be done in any suitable manner. For example, displaying the suitable alternative waypoints 54 in a distinguishable manner may include displaying the suitable alternative waypoints 54 with at least one of a different color and a different opacity from the remainder of the flight plan 42.

It is contemplated that once the suitable alternative waypoints 54 are displayed, the user may select the suitable alternative waypoints 54 for its inclusion in the flight plan 42. The selection of the suitable alternative waypoints 54 may be received by the controller 30. Once the controller 30 has received such a user selection the waypoints 46 and the portions of the flight plan 47 that have been determined to be unsuitable may be removed from the flight display 22 and the suitable alternative waypoints 54 may be displayed as being undistinguishable from the remainder of the flight plan 42 and any other waypoints displayed on the flight display 22. Further, the suitable alternative waypoints 54 may be considered by the controller 30 to be included within the flight plan.

The controller 30 may further alert the user that the display indicia related to the unsuitability of the at least a portion of the flight plan has been displayed. This may include causing the indicia to flash or brighten on the flight display 22. Many graphical and illustrative techniques may be used to draw the user's attention to the display indicia. The controller 30 may also audibly alert the user using any suitable mechanism located in the flight deck 18.

A variety of scenarios may render a flight plan that was initially suitable to be unsuitable based on at least one suitability criteria. For example, a greater headwind may be encountered during flight, which may reduce the amount of fuel available to fly the remainder of the flight plan. Such a scenario may cause the destination arrival time to be pushed back because higher altitudes may not be reachable. Further, the aircraft may initially be stuck on the runway, may encounter weather, or may not burn fuel at the expected rate due to engine characteristics. Currently when such scenarios occur a pilot must determine if such factors are important. Depending on the perceived importance, the pilot may or may not relay such factors to ground control. The pilot depending on the perceived importance may ask for a reroute from ground control. If the pilot has conveyed such information to the ground control and ground control deems the scenario worthy, then ground control may reroute the plane regardless of whether the pilot has asked for a re-route. It will be understood that a variety of information must be perceived, judgments regarding the importance of such information must be made, and this may all take a considerable amount of time and effort.

The above described embodiments provide a variety of benefits including that an entered flight plan along with various information may be analyzed and the aircraft may present the pilot with a list of points along the entered flight plan that have been found to be unsuitable based thereon. Embodiments above present alternative segments of the flight plan to give the user a new flight plan that will satisfy the criteria and provide the user with an acceptable flight plan alternative without additional input being needed from the user. The above embodiments simplify the pilot interface and allow for time savings in that the user does not have to manually account for this data. Instead, standards for the flight plan may be set and then the user may be quickly and intuitively be shown any issues in the flight plan both before and during flight.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of displaying a flight plan on a display of a flight deck of an aircraft, the method comprising:
displaying at least a portion of the flight plan on the display;
determining an unsuitability of the at least a portion of the flight plan based on at least one suitability criteria; and
displaying on the display indicia related to the determined unsuitability.

2. The method of claim 1 wherein the at least a portion of the flight plan is a waypoint.

3. The method of claim 2 wherein the displaying the indicia comprises flagging the waypoint.

4. The method of claim 3 wherein displaying the indicia comprises displaying a user-selectable flagged waypoint.

5. The method of claim 4, further comprising displaying information regarding the unsuitability of the waypoint upon the selection of the user-selectable flagged waypoint.

6. The method of claim 1, further comprising displaying at least one suitable alternative waypoint location when the at least a portion of the flight plan is determined to be unsuitable.

7. The method of claim 6 wherein the at least one suitable alternative waypoint location is determined based on at least one of weather, terrain, fixed obstacles, variable obstacles, and flight characteristics of the aircraft.

8. The method of claim 1 wherein the determining an unsuitability comprises comparing a trajectory of the aircraft along the flight plan against the at least one suitability criteria.

9. The method of claim 8 wherein comparing the trajectory comprises generating a predicted trajectory based on at least one of weather, current time, location of the aircraft, and flight characteristics of the aircraft.

10. The method of claim 8 wherein the suitability criteria includes at least one of pilot suitability criteria and airline suitability criteria.

11. The method of claim 8 wherein the suitability criteria includes at least one of destination arrival time, weather preferences, and proximity preferences.

12. The method of claim 1 wherein the determining the unsuitability of the at least a portion of the flight plan includes determining the unsuitability while the aircraft is being flown along the flight plan.

13. The method of claim 1 wherein the indicia is associated with a corresponding portion of the flight plan.

14. The method of claim 13 wherein the indicia is displayed near the corresponding portion of the flight plan.

15. The method of claim 13 wherein the indicia is displayed on the corresponding portion of the flight plan.

16. The method of claim 13 wherein the indicia is displayed as a suitable alternative to the at least a portion of the flight plan.

17. The method of claim 16 wherein the suitable alternative is a suitable waypoint.

18. The method of claim 1, further comprising alerting a user that the display indicia related to the unsuitability of the at least a portion of the flight plan has been displayed.

19. The method of claim 18 wherein the alerting the user includes audibly alerting the user.

20. The method of claim 1 wherein the displaying on the display indicia related to the determined unsuitability comprises displaying indicia related to the at least a portion of the flight plan that is determined to be unsuitable.
